(19) United States
(12) Patent Application Publication
(10) Pub. No.: US 2010/0002005 A1
(43) Pub. Date: Jan. 7, 2010

(54) IMAGE DISPLAY APPARATUS, INTEGRATED CIRCUIT, AND COMPUTER PROGRAM

(76) Inventors: Yuji NAGAISHI, Osaka (JP); Hidetoshi Takeda, Osaka (JP); Takahiro Kobayashi, Okayama (JP)

Correspondence Address: WENDEROTH, LIND & PONACK L.L.P., 1030 15th Street, N.W., Suite 400 East, Washington, DC, 20005-1503, US

(21) Appl. No.: 12/495,940

(22) Filed: Jul. 1, 2009

(30) Foreign Application Priority Data
Jul. 4, 2008 (JP) 2008-176279

(51) Int. Cl. G06K 9/48; G06T 1/00

(52) U.S. Cl. 345/522; 382/197

(57) ABSTRACT

Achieved are suppression of image-quality deterioration caused by an incorrect motion vector and suppression of flicker in video without causing adverse effects such as image blur. A video display apparatus performs multi-level gradation display by controlling light emission of subfields into which one field displaying a picture is divided, the video display apparatus comprising: an image processing unit configured to calculate a motion vector of the picture; a reliability value calculation unit configured to calculate a reliability value of the calculated motion vector; and a subfield display control unit configured to determine a subfield control pattern based on the calculated reliability value, and to control the light emission according to the determined subfield control pattern.

### BACKGROUND OF THE INVENTION

(1) Field of the Invention

The present invention relates to a plasma display, and particularly to a video display method and a video display apparatus for performing display control to suppress flicker and deterioration in video resolution.

(2) Description of the Related Art

Half-tone display by plasma displays (hereinafter referred to as PDPs) is achieved by displaying subfields having different luminance weights into which one field is divided. It is known that when images with motions are displayed by dividing one field into plural subfields by time division, image blur and pseudo-contours in video occur due to a mismatch between the sight-line movement direction and half-tone display positions.

As a method to reduce such occurrence, Patent Reference 1 (Japanese Unexamined Patent Application Publication No. 9-138666) discloses correcting display positions of subfields in the moving direction of video and displaying the video accordingly.

FIG. 7 illustrates an example of the case of not correcting display positions of subfields.

FIG. 8 illustrates an example of the case of correcting display positions of subfields.

For example, FIG. 7 illustrates an example of displaying video by causing four subfields (SF4, SF3, SF2, SF1) to emit light. The shaded areas show subfields that are emitting light. The two broken arrows represent a sight-line movement direction, and when the distance between these arrows is large, image blur and pseudo-contours in video occur.

Considering this problem, the technique disclosed in Patent Reference 1 aims at reducing the distance between the arrows by shifting the light-emission positions of subfields in one field to other pixel positions along the sight-line movement direction so as to suppress image blur and pseudo-contours in video.

In contrast, the flicker reduction method disclosed in Patent Reference 2 (Japanese Unexamined Patent Application Publication No. 10-319903) changes the light-emission luminance weights of subfields depending on whether the video to be displayed is still picture-based video or moving picture-based video. In the case of still picture-based video, flicker is suppressed by dispersing subfields having larger luminance weights.

### SUMMARY OF THE INVENTION

The sight-line movement direction, however, cannot be detected correctly in some cases.

The video display apparatus disclosed in Patent Reference 1 leads to an improvement in reducing image blur and pseudo-contours when the sight-line movement direction is correctly detected. However, when the sight-line movement direction is not correctly detected, that is, for example, when a direction 180 degrees different from the actual sight-line movement direction is detected, there is a problem that the display quality rather deteriorates because the subfields are displayed along the direction 180 degrees different from the actual sight-line movement direction.

The video display apparatus disclosed in Patent Reference 2 is intended to change the light-emission luminance weights depending on whether the video to be displayed is still picture based or moving picture based, and suppresses flicker especially in still picture-based video. Therefore, when the technique of Patent Reference 2 is adopted in displaying moving picture-based video, flicker cannot be adequately suppressed because although the sight line moves, the subfields having larger luminance weights at the position before the sight-line movement emit light, resulting in image blur and so on. Further, there is also a problem that incorrect detection of moving pictures and still pictures causes deterioration in the display quality.

The present invention has been conceived in order to solve the above problems, and an object of the present invention is to provide a video display apparatus that suppresses image blur and flicker by estimating a motion vector for correct determination of the sight-line movement direction, as well as calculating a reliability value of the estimated motion vector and changing display control patterns according to the reliability value.

In order to achieve the object set forth above, the image display apparatus according to the present invention employs the following structure.

An image display apparatus according to a first aspect of the present invention is an image display apparatus which performs multi-level gradation display of a picture of one field by controlling light emission of subfields into which the field is divided, the image display apparatus comprising: a motion vector calculation unit configured to calculate a motion vector of the picture which is a first picture; a reliability value calculation unit configured to calculate a reliability value of the calculated motion vector; and a subfield display control unit configured to determine a subfield control pattern based on the calculated reliability value, and to control the light emission according to the determined subfield control pattern.

With this structure, the reliability value of the calculated motion vector is calculated, a control pattern is determined based on the calculated reliability value representing a likelihood that an incorrect motion vector has been calculated, and light-emission control is performed according to the determined control pattern. As a result, it is possible to suppress deterioration of image quality caused by an incorrect motion vector.

In addition, although video having a motion indicated by the calculated motion vector is displayed, by calculating the reliability value of the calculated motion vector, determining a control pattern based on the calculated reliability value, and performing light-emission control according to the determined control pattern, it is possible to suppress light emission of subfields having larger luminance weights at inappropriate positions based on an incorrect motion vector, and to achieve sufficient improvement in performance while suppressing image blur and flicker.

It is to be noted that the picture of one field is, for example, a set of pixels to be displayed by one field.

The subfields are created by dividing, by time division, one field into smaller fields such that each of the smaller fields has a part of the duration of the one field and is thus shorter than the one field in time.

Further, for example, the image display apparatus controls light emission of the subfields such that only some of the subfields emit light and others do not. By causing light emission of only some of the subfields that represent the gradation levels of the picture of the one field, the image display apparatus performs multi-level gradation display of the picture having multiple gradation levels.

The subfields are used for multi-level gradation display by plasma displays, for example, and the subfield display control unit controls light emission of subfields for the plasma displays.

An image display apparatus according to a second aspect of the present invention is the image display apparatus according to the first aspect of the present invention, wherein the motion vector calculation unit is configured to specify a second picture which is different from the first picture in time but has pixels that match pixels of the first picture, and to calculate a vector between the first picture and the second picture as the motion vector of the first picture, and the reliability value calculation unit is configured to calculate a reliability value based on: a sum of differences between the pixels of the first picture and the pixels of the second picture; and respective motion vectors of pictures surrounding the first picture for which the motion vector has been calculated, the reliability value becoming greater as an absolute value of the sum of the differences between the pixels decreases and as a difference between the calculated motion vector and each of the respective motion vectors of the surrounding pictures decreases.

This structure allows the motion vector calculation and the reliability value calculation to be performed with a simple structure, which in turn makes it possible to provide the image display apparatus with a simple structure.

It may be that the reliability value calculation unit calculates a greater reliability value when the difference between the calculated motion vector and a motion vector that is an average of the motion vectors of the surrounding pictures is smaller. It may further be that the reliability value calculation unit calculates a greater reliability value when the difference between the calculated motion vector and each of the motion vectors of the surrounding pictures is smaller, or that it calculates a greater reliability value when the difference between the calculated motion vector and each of only some of the motion vectors of the surrounding pictures is smaller.

An image display apparatus according to a third aspect of the present invention is the image display apparatus according to the second aspect of the present invention, wherein the subfield display control unit is configured to cause the respective subfields to emit light at predetermined pixel positions with respective timings specified for the subfields according to the determined control pattern, the pixel positions at which the light emission occurs are pixel positions shifted from a pixel position of a motion-vector-starting-point subfield at which the calculated motion vector makes a starting point, according to the calculated motion vector, the shift to the light-emission pixel positions is a shift in time from a light-emission timing of the motion-vector-starting-point subfield to the respective timings of the subfields, and the subfield display control unit is configured to determine, as the control pattern, a first control pattern when the calculated reliability value is greater than a predetermined threshold, and a second control pattern different from the first control pattern when the calculated reliability value is equal to or smaller than the predetermined threshold.

With this structure, the timings and pixel positions of the subfields to be used are changed depending on whether the reliability value is higher than a threshold value or the reliability value is equal to or less than the threshold value, which makes it possible to suppress image-quality deterioration caused by an incorrect motion vector to a greater extent.

An image display apparatus according to a fourth aspect of the present invention is the image display apparatus according to the third aspect of the present invention, wherein the first control pattern determined when the calculated reliability value is greater is a control pattern in which respective timings of subfields having a light-emission time period equal to or longer than a predetermined period are dispersed, and the second control pattern determined when the calculated reliability value is not greater is a control pattern in which the respective timings of the subfields having the light-emission time period equal to or longer than the predetermined period are concentrated.

An image display apparatus according to a fifth aspect of the present invention is the image display apparatus according to the fourth aspect of the present invention, wherein the second control pattern determined when the calculated reliability value is not greater is a control pattern that defines, only for a subfield having a timing that is closer to the timing of the motion-vector-starting-point subfield than a timing determined by the first control pattern for a predetermined subfield, a light-emission time period equal to or longer than a light-emission time period determined by the first control pattern for the predetermined subfield.

With this structure, the second control pattern determined in the case of a low reliability value is a control pattern in which the subfields having a long light-emission time period are only the subfields close to the timing of a motion-vector-starting-point subfield, and thus the timings of the subfields having a long light-emission time period are concentrated, whereas the first control pattern determined in the case of a high reliability value is a control pattern in which some of the subfields having a long light-emission time period are away from the timing of the motion-vector-starting-point subfield, and thus the timings of the subfields having a long light-emission time period are dispersed.

It is to be noted, for example, that the predetermined period according to the fourth aspect of the image display apparatus may have the same length as the light-emission time period determined for a predetermined subfield according to the fifth aspect of the image display apparatus.

Thus, in the case of a low reliability value, the subfields having a long light-emission time period emit light only near the motion-vector-starting-point pixel position, thereby making it possible to adequately suppress the image-quality deterioration caused by an incorrectly calculated motion vector.

Further, in the case of a high reliability value, some of the subfields having a long light-emission time period emit light even at pixel positions away from the motion-vector-starting-point pixel position, and thus the light-emission timings of the subfields having a long light-emission time period are dispersed, thereby making it possible to prevent flicker caused by light emission, within a short period of time, of the subfields having a long light-emission time, and thus flicker can be reliably suppressed.

It is to be noted that with the image display apparatus, the first control pattern determined in the case of a high reliability value may be a control pattern that defines a subfield other than the motion-vector-starting-point subfield and having a light-emission time period equal to or longer than that of the motion-vector-starting-point subfield.

An image display apparatus according to a sixth aspect of the present invention is the image display apparatus according to the third aspect of the present invention, wherein the first control pattern determined when the calculated reliability value is greater is a control pattern in which respective timings of subfields having a light-emission time period longer than a predetermined period are equally dispersed.

An image display apparatus according to a seventh aspect of the present invention is the image display apparatus according to the sixth aspect of the present invention, wherein the first control pattern is a control pattern in which the number of local-maximum-point subfields is larger than the number of local-maximum-point subfields of the second control pattern, each of the local-maximum-point subfields having a light-emission time period longer than each of light-emission time periods of adjacent subfields.

With this structure, the first control pattern determined in the case of a high reliability value is a control pattern having a larger number of local maximum points and thus there are many subfields having a long light-emission time period. Therefore, the timings of the subfields having a long light-emission time period are equally dispersed, thereby allowing adequate suppression of flicker.

It is to be noted, for example, that the predetermined period according to the sixth aspect of the image display apparatus may be a light-emission time period serving as a standard reference for determining that the above “long” light-emission time period can be considered to be long.

An image display apparatus according to an eighth aspect of the present invention is the image display apparatus according to the fourth aspect of the present invention, wherein the first control pattern is a control pattern in which a total length of the respective light-emission time periods defined for the subfields is equal to a total length of the light-emission time periods defined by the second control pattern, and in which a longest light-emission time period of the light-emission time periods is shorter than a longest light-emission time period of the light-emission time periods defined by the second control pattern.

With this structure, the first control pattern determined in the case of a high reliability value is the same as the second control pattern in terms of the total length of the light-emission time periods; however, in the first control pattern, the period of the longest light-emission time is shorter, which allows subfields other than the subfield having the longest light-emission time period to have a long light-emission time period. As a result, light emission of plural subfields having a long light-emission time period allows dispersion of the light-emission timings of the subfields having a long light-emission time period, thereby making it possible to more adequately suppress flicker.

An image display apparatus according a ninth aspect of the present invention is the image display apparatus according to the third aspect of the present invention, wherein the subfield display control unit is configured to cause the subfields to emit light at respective pixel positions based on a motion vector having a magnitude reduced to a predetermined proportion of a magnitude of the motion vector calculated by the motion vector calculation unit when the reliability value calculated by the reliability value calculation unit is smaller than a predetermined threshold.

With this structure, when there is a possibility that an incorrect motion vector with a low reliability value is calculated, each subfield emits light at a pixel position closer to the motion-vector-starting-point pixel position, thereby allowing more adequate suppression of image-quality deterioration caused by an incorrect motion vector.

In addition, each subfield emits light not at the motion-vector-starting-point pixel position but at a pixel position away from the motion-vector-starting-point pixel position by a distance according to the predetermined proportion, thereby achieving suppression of image-quality deterioration caused by motions in pictures. This means that it is possible to achieve both the suppression of image-quality deterioration caused by motions in pictures and the suppression of image-quality deterioration caused by an incorrect motion vector.

An image display apparatus according to a tenth aspect of the present invention is the image display apparatus according to the third aspect of the present invention, wherein the subfield display control unit is configured to: cause the subfields to emit light at respective pixel positions each of which is shifted from the pixel position of the motion-vector-starting-point subfield, only when the calculated reliability value is greater than the threshold; and cause all the subfields to emit light at the pixel position of the motion-vector-starting-point subfield when the reliability value is equal to or smaller than the threshold.

With this structure, in the case of a low reliability value, each subfield emits light at the motion-vector-starting-point pixel position, thereby making it possible to reliably and adequately suppress image-quality deterioration caused by an incorrect motion vector.

Further, an image display apparatus as follows may be adopted.

That is, the image display apparatus is an image display apparatus which performs multi-level gradation display by causing light emission of a field divided into subfields, and the image display apparatus comprises: a motion vector calculation unit configured to calculate a motion vector between frames; a reliability value calculation unit configured to calculate a reliability value of the calculated motion vector; and a subfield display control unit configured to determine a subfield control pattern based on the calculated reliability value, and to control light emission according to the determined subfield control pattern.

Preferably, the image display apparatus calculates the reliability value based on a sum of differences in pixels between different fields and motion vector information of surrounding pixels.

Further, the image display apparatus preferably performs the subfield display control by correcting light-emission positions of the subfields based on the calculated motion vector and by selecting a light-emission pattern in which subfields having large luminance weights are dispersed when the reliability value is equal to or greater than a predetermine value and selecting a light-emission pattern in which the subfields having large luminance weights are concentrated when the reliability value is smaller than the predetermine value.

Furthermore, the image display apparatus preferably performs the subfield display control by correcting the light-emission positions of the subfields based on the calculated motion vector and by selecting a light-emission pattern in which the subfields having large luminance weights are equally dispersed when the reliability value is equal to or greater than a predetermine value.

Further, when correcting the light-emission positions of the subfields based on the calculated motion vector to perform the subfield display control, the image display apparatus preferably corrects the motion vector calculated by the motion vector calculation unit according to the reliability value calculated by the reliability value calculation unit, and corrects the light-emission positions of the subfields based on the corrected motion vector.

With the image display apparatus having such a structure, controlling light-emission positions and light-emission patterns of the subfields according to the reliability of motion vectors causes emphasized light emission when the estimated motion vector is correct and less emphasized light emission when the estimated motion vector appears incorrect, thereby suppressing image blur and pseudo-contours in video.

It is to be noted that the present invention can be embodied not only as an image display apparatus having such units, but also as a method, a software program, and an integrated circuit of a semiconductor.

Alternatively, an image display apparatus as follows may be adopted.

That is, an image display apparatus which controls subfields by estimating a motion vector, and determines, via a reliability calculation unit, reliability of a motion vector calculated by a motion vector calculation unit, and, via a subfield display control unit, disperses light emission of subfields having high luminance in a direction of the motion vector when the reliability is high, and concentrates the light emission in the direction of the motion vector when the reliability is low, thereby suppressing image blur, flicker, and so on. In other words, an image display apparatus may be adopted which suppresses image blur, flicker, and so on in a plasma display that controls light emission through subfield control based on a motion vector and reliability thereof.

The present invention makes it possible to suppress occurrence of image blur and pseudo-contours in video in plasma displays that perform light-emission control by controlling subfields.

### FURTHER INFORMATION ABOUT TECHNICAL BACKGROUND TO THIS APPLICATION

The disclosure of Japanese Patent Application No. 2008-176279 filed on Jul. 4, 2008 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram illustrating an example of a structure of an image display apparatus according to an embodiment of the present invention applied to a plasma display;

FIG. 2 is an explanatory diagram of surrounding pixel blocks;

FIG. 3A illustrates a light-emission pattern of subfields which is determined when the reliability of a motion vector is low;

FIG. 3B illustrates a light-emission pattern of subfields which is determined when the reliability of a motion vector is high;

FIG. 4A schematically illustrates a light-emission pattern in which light-emission positions of subfields having larger luminance weights are changed;

FIG. 4B schematically illustrates a light-emission pattern in which light-emission positions of subfields having larger luminance weights are changed;

FIG. 4C schematically illustrates a light-emission pattern in which light-emission positions of subfields having larger luminance weights are changed;

FIG. 5A is a diagram for describing that image blur can be suppressed by causing light emission in such a manner that the subfields having larger luminance weights are equally dispersed;

FIG. 5B is a diagram for describing that image blur can be suppressed by causing light emission in such a manner that the subfields having larger luminance weights are equally dispersed;

FIG. 5C is a diagram for describing that image blur can be suppressed by causing light emission in such a manner that the subfields having larger luminance weights are equally dispersed;

FIG. 6 is a flowchart of an operation performed by a video display apparatus;

FIG. 7 illustrates an example of performing a display by causing four subfields (SF4, SF3, SF2, SF1) to emit light; and

FIG. 8 illustrates an example of performing a display by causing light emission with display positions of subfields along a sight-line movement direction.

### DESCRIPTION OF THE PREFERRED EMBODIMENT(S)

With reference to the drawings, an embodiment of an image processing apparatus (image display apparatus) according to the present invention shall be hereinafter described.

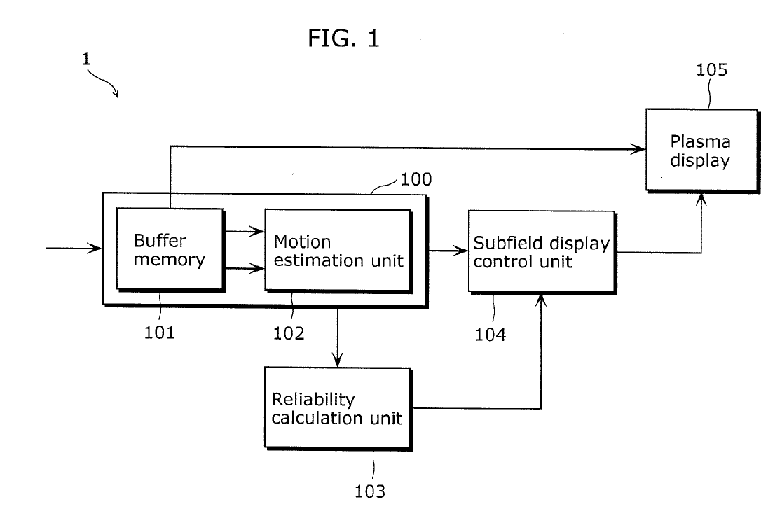

FIG. 1 is a block diagram of a video display apparatus 1 according to the present embodiment.

The video display apparatus 1 includes: an image processing unit 100 which contains a buffer memory 101 and a motion estimation unit 102; a reliability calculation unit 103; a subfield display control unit 104; and a plasma display 105.

It should be noted that the image processing unit 100, the reliability calculation unit 103, and the subfield display control unit 104 are, for example, functional blocks realized on a substrate of a driving chip provided in the plasma display 105 for driving the plasma display 105. Here, the driving chip is provided in the plasma display 105, for example.

Pictures to be displayed by the plasma display 105 are temporarily accumulated in the buffer memory 101 of the image processing unit 100 via a TV tuner or the like.

The buffer memory 101 obtains and accumulates pictures to be displayed. The buffer memory 101 accumulates picture data of several frames, depending on the memory capacity, and is accessed from the motion estimation unit 102 as necessary.

The motion estimation unit 102 calculates a motion vector from the frames accumulated in the buffer memory 101. For example, the motion estimation unit 102 obtains two pieces of picture data, namely, picture data of a frame at which a motion vector to be calculated makes a starting point, and picture data of a frame at which the motion vector makes an endpoint. Based on these two pieces of picture data, the motion estimation unit 102 calculates a motion vector.

The reliability calculation unit 103 determines a reliability value of the motion vector estimated by the motion estimation unit 102, based on a sum of differences in pixels between fields provided by the motion estimation unit 102 and motion vector information of surrounding pixels.

It is to be noted that the reliability value of a motion vector indicates the likelihood that the estimated motion vector matches the actual motion vector. The higher the likelihood, the higher the reliability value becomes.

The subfield display control unit 104 controls light emission by determining a light-emission order and correction of light-emission positions of subfields based on the information provided from the motion estimation unit 102 and the reliability calculation unit 103.

The plasma display 105 emits light according to the control by the subfield display control unit 104.

Next, processing of each block shall be described in detail.

The motion estimation unit 102 calculates a motion vector by pixel block matching. The matching is performed per, for example, small region of pixels such as 8×8 pixels. A motion vector is calculated by performing a sum-of-absolute-difference (hereinafter referred to as SAD) operation on regions to be matched, and detecting a region with the smallest difference.

It should be noted that the present embodiment illustrates an example of performing motion vector calculation by block matching, but it may be performed by pixel matching if the processing amount permits.

The reliability calculation unit 103 determines a reliability value of the motion vector calculated by the motion estimation unit 102 based on the result of the SAD operation performed by the motion estimation unit 102 and motion vector information of surrounding pixel blocks.

As shown below, a reliability value is a product of a reliability coefficient 1 and a reliability coefficient 2. The reliability coefficient 1 is a coefficient determining whether or not there is an error on or above a certain level, and the reliability coefficient 2 is a sum of differences in vector between the current block and surrounding blocks.

Reliability Coefficient 1=if (SAD<Threshold) 0 else SAD;

Reliability Coefficient 2=Σ(Motion Vector of Surrounding Block−Motion Vector of Current Block);

Reliability Value=Reliability Coefficient 1×Reliability Coefficient 2;

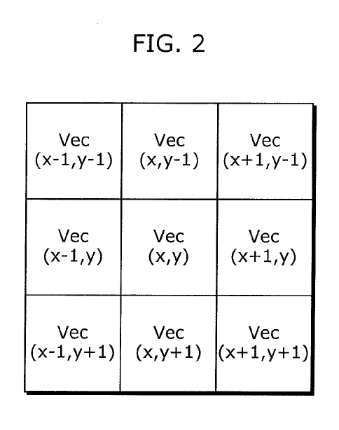

FIG. 2 illustrates relationships with surrounding pixel blocks in the reliability value calculation. Assuming Vec (x, y) as the motion vector of the current block for which a reliability value is to be calculated, the reliability coefficient 2 is calculated by summing differences between the motion vector of the current block and the motion vectors of the surrounding eight blocks. In such a manner, in the present embodiment, the reliability coefficient 2 is calculated with 3×3 blocks, but the region of the surrounding blocks is not limited to 3×3. For example, it may be 5×5 blocks, or 9×9 blocks.

The subfield display control unit 104 performs light-emission control of causing light emission after correcting light-emission positions of subfields according to the sight-line movement direction based on the motion vector estimated by the motion estimation unit 102.

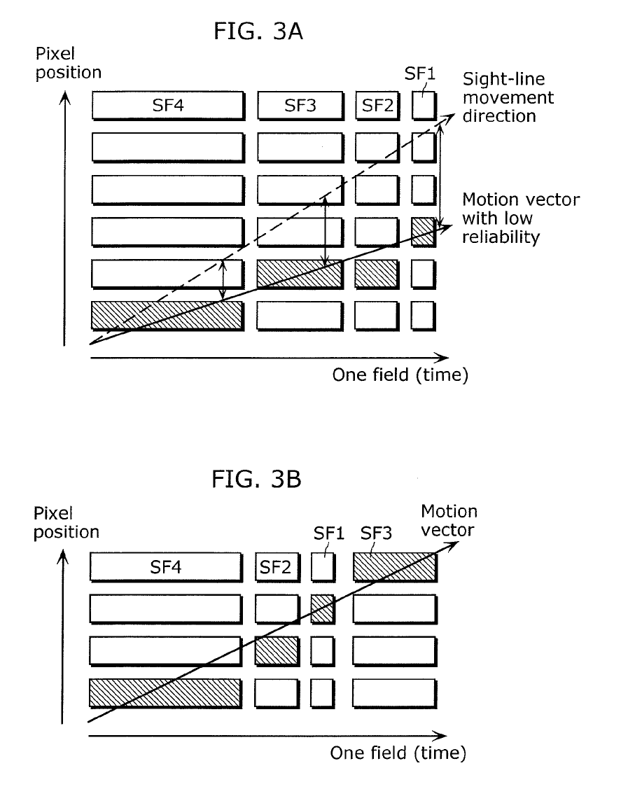

FIGS. 3A and 3B illustrate examples of light-emission positions of subfields SF1 to SF4, corrected based on a motion vector.

In FIGS. 3A and 3B, the vertical axis represents pixel position and the horizontal axis represents duration of one field. Each of the solid oblique arrows in FIGS. 3A and 3B indicates a motion vector.

Here, the lowest pixel position among the six pixel positions shown in FIGS. 3A or among the four pixel positions shown in FIGS. 3B is the position of the pixel to be expressed by one-field light emission caused by the subfield display control unit 104, among the pixels of a display picture stored in the buffer memory 101.

The subfield display control unit 104 obtains from the motion estimation unit 102, a motion vector that makes a starting point at the position of the pixel to be expressed by light emission of one field (the lowest pixel position), and uses the motion vector for the light-emission control over the field containing that pixel.

The subfield display control unit 104 causes subfields, into which the field has been divided, to emit light at pixel positions shifted from the above mentioned pixel position of the field (the lowest pixel position) along the direction of the calculated motion vector. That is, the subfield display control unit 104 corrects the pixel positions of the subfields from the pixel position of the field (the lowest pixel position) to pixel positions shifted along the motion vector direction (the upper direction in FIGS. 3A and 3B).

FIG. 3A illustrates an example of correcting the light-emission positions of subfields SF4, SF3, SF2, and SF1 of the field targeted for light-emission, along the upper direction of FIG. 3A by 0 pixels, 1 pixel, 1 pixel, and 2 pixels, respectively. FIG. 3B illustrates an example of correcting the light-emission positions of subfields SF4, SF3, SF2, and SF1 of the field targeted for light-emission, along the upper direction of FIG. 3B by 0 pixels, 1 pixel, 2 pixels, and 3 pixels, respectively.

The subfield display control unit 104 corrects the light-emission positions of the subfields by shifting, along the motion vector direction, from the motion-vector-starting-point pixel position to the positions of the subfields along the horizontal axis in FIGS. 3A and 3B, that is, to the respective timings of the subfields in the duration of the field.

Further, the subfield display control unit 104 switches between plural subfield-light-emission patterns according to the reliability value calculated by the reliability calculation unit 103.

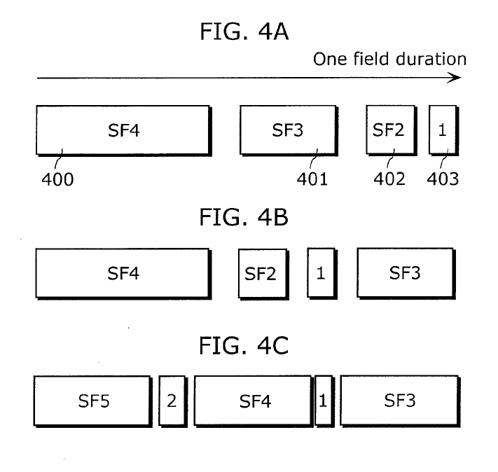

FIGS. 4A to 4C schematically illustrate examples of light-emission patterns of performing a display using four subfields. FIG. 4A illustrates a light-emission pattern in which subfields emit light in order of descending luminance weights. FIG. 4B illustrates a light-emission pattern in which subfields having larger luminance weights are dispersed. FIG. 4C illustrates a light-emission pattern in which the subfields having larger luminance weights are dispersed relatively equally.

These light-emission patterns are switched by the subfield display control unit 104 according to the reliability value calculated by the reliability calculation unit 103.

For example, the subfield display control unit 104 sets a plurality of threshold levels for reliability value, and switches between the light-emission patterns according to the threshold levels. When the reliability value is at or below a threshold level and indicates that the reliability is low, the subfield display control unit 104 causes light emission according to the light-emission pattern shown in FIG. 4A in which the luminance weights are sequentially switched. This way, light emission concentrates at the subfields having larger luminance weights, thereby minimizing the adverse effects caused by misestimation of a motion vector. On the other hand, when the reliability value is above the threshold level and indicates that the reliability is high, the subfield display control unit 104 selects the light-emission pattern shown in FIGS. 4B or 4C in which the light emission of the subfields having larger luminance weights is dispersed as equally as possible. This way, the light emission of the subfields having larger luminance weights is dispersed, thereby producing advantages of not only suppressing flicker, but also suppressing image blur and pseudo-contours in video because the subfields emit light along the sight-line movement direction based on the correctly estimated motion vector.

Here, FIG. 3A illustrates a light-emission pattern of subfields when the reliability of the motion vector is low (FIG. 4A) and FIG. 3B illustrates a light-emission pattern of subfields when the reliability of the motion vector is high (FIG. 4B). The motion vector shown in FIG. 3A is assumed to be one with low reliability, whereas the motion vector shown in FIG. 3B is assumed to be one with high reliability.

The light-emission pattern shown in FIG. 3A is selected when a motion vector with low reliability is estimated. When the calculated reliability value is low, the estimated motion vector is often an incorrect motion vector. That is, the estimated motion vector is, in many cases, outside a predetermined proximity range of the actual, correct motion vector (the broken arrow in FIG. 3A). When a motion vector with low reliability is estimated (FIG. 3A), the subfield display control unit 104 causes the subfields to emit light in order of descending luminance weights. This way, the difference between the sight-line movement direction and the more noticeable subfields having larger luminance weights is minimized, thereby allowing suppression of image blur.

On the other hand, when the reliability is high (FIG. 3B), the estimated motion vector is likely to be a correct motion vector; that is, it is likely to be within a proximity range of the actual, correct motion vector. In such a case where the reliability is high (FIG. 3B), the subfield display control unit 104 suppresses flicker by dispersing the subfields having larger luminance weights as shown in FIG. 4B.

It is to be noted that when the reliability is determined to be low, the subfield display control unit 104 does not need to apply the estimated motion vector as it is. More precisely, the estimated motion vector value does not need to be used 100%, but it may be multiplied by a gain, and the gain-applied motion vector, which is less than 100% of the estimated motion vector, may be used to make the difference from the sight-line movement direction less noticeable, thereby allowing suppression of problems.

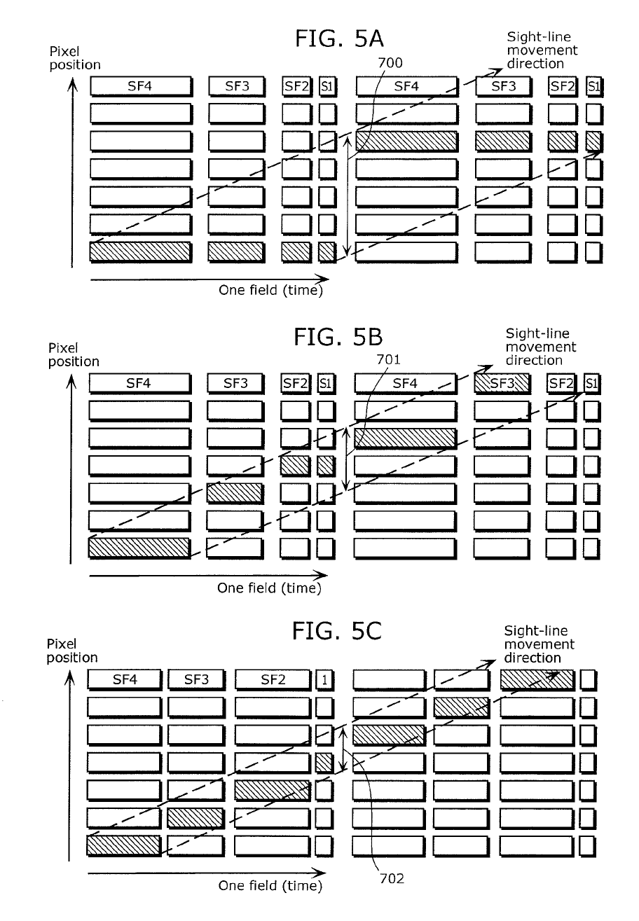

FIGS. 5A to 5C are diagrams for describing that image blur can be suppressed by causing light emission in such a manner that the subfields having larger luminance weights are equally dispersed.

In FIGS. 5A to 5C, the right half of the diagrams corresponds to a time that follows immediately after the time of the left half.

FIG. 5A illustrates a light-emission pattern in which the subfield shifting is not performed. FIG. 5B illustrates a light-emission pattern in which subfields are caused to emit light in order of descending luminance weights (see FIG. 4A). FIG. 5C illustrates a light-emission pattern in which light emission of subfields with large luminance weights is dispersed (see FIG. 4B). In FIG. 5A, image blur is represented by a distance 700 between two broken arrows that indicate a sight-line movement direction. In FIG. 5B, image blur is represented by a distance 701, and in FIG. 5C, it is represented by a distance 702. In FIG. 5C, the light emission is equally dispersed and thus the light-emission time periods of the respective subfields having the largest luminance weight are shortened. As a result, the distance representing the image blur is made small compared with FIGS. 5A and 5B, which means that the blur is suppressed. That is to say, when a motion vector is correctly estimated, it is possible to suppress image blur by causing light emission in such a manner as shown in FIG. 5C.

It is to be noted that the subfield display control unit 104 may use any of the following pairs of light-emission patterns when the reliability of the motion vector is low and high: a pair of light-emission patterns of FIG. 4A (FIG. 3A) and FIG. 4B (FIG. 3B); a pair of light-emission patterns of FIG. 4A (FIG. 3A) and FIG. 4C; and a pair of light-emission patterns of FIG. 5B (FIG. 3A) and FIG. 5C (FIG. 3B).

Further, in each of the above pairs of light emission patterns, the subfield display control unit 104 may use a light-emission pattern as shown in FIG. 5A in which the subfield shifting is not performed when the reliability of the motion vector is low.

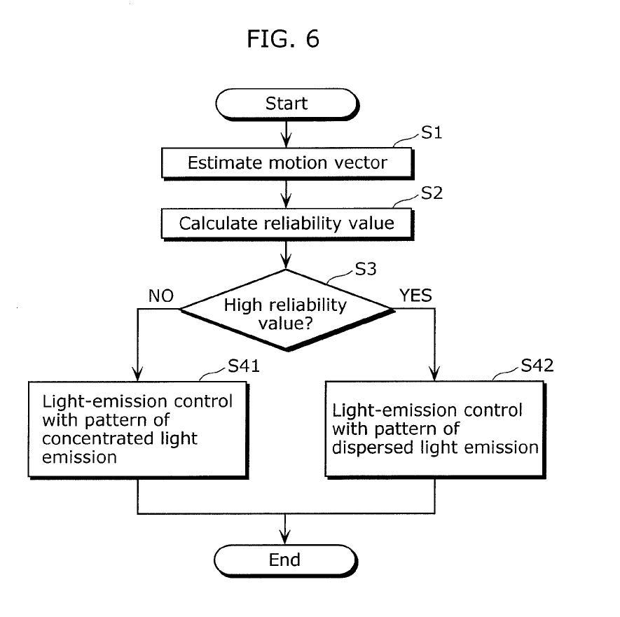

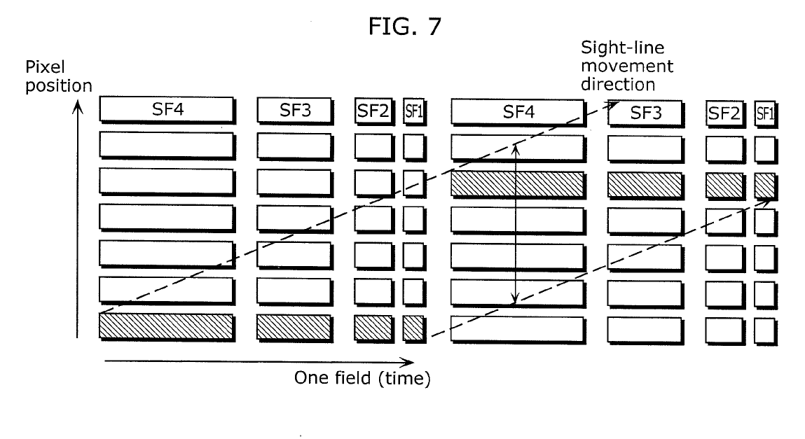

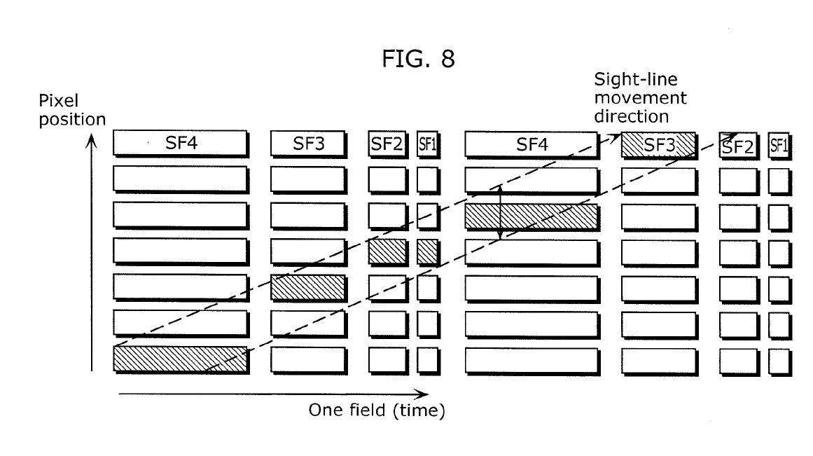

FIG. 6 is a flowchart of the operation performed by the video display apparatus 1. In Step S1, the motion estimation unit 102 (FIG. 1) estimates a motion vector of a frame accumulated in the buffer memory 101.

In Step S2, the reliability calculation unit 103 calculates a reliability value of the motion vector estimated by the motion estimation unit 102 in Step 1.

In Step S3, the subfield display control unit 104 determines whether the reliability value calculated in Step 2 is above a threshold level, indicating high reliability, or at or below the threshold level, indicating low reliability.

If the reliability is determined to be high (Step 3: YES), in Step S42, the subfield display control unit 104 causes the plasma display 105 to emit light by performing light-emission control using a light-emission pattern for high reliability (for example, the light-emission pattern of FIG. 4B).

If the reliability is determined to be low (Step 3: NO), in Step S41, the subfield display control unit 104 causes the plasma display 105 to emit light by performing light-emission control using a light-emission pattern for low reliability (for example, the light-emission pattern of FIG. 4A).

The light emission order of subfields according to the present embodiment has been described based on an assumption that subfields emit light in order of descending luminance weights as shown in FIG. 4A. Even when the subfields emit light in order of ascending luminance weights, however, the processing illustrated in the present embodiment can be applied by calculating the starting point of a motion vector at a position of a subfield having a larger luminance weight.

As described, the image display apparatus (the video display apparatus 1) is structured which performs multi-level gradation display of a picture of one field by controlling light emission of subfields into which the field is divided, the image display apparatus comprising: a motion vector calculation unit (the image processing unit 100) configured to calculate a motion vector of the picture which is a first picture; a reliability value calculation unit (the reliability calculation unit 103) configured to calculate a reliability value of the calculated motion vector; and a subfield display control unit (the subfield display control unit 104) configured to determine a subfield control pattern (such as the control patterns shown in FIGS. 3A and 3B) based on the calculated reliability value, and to control the light emission according to the determined subfield control pattern.

With this structure, the reliability value of the calculated motion vector is calculated, a control pattern is determined based on the calculated reliability value representing a likelihood that an incorrect motion vector has been calculated, and light-emission control is performed according to the determined control pattern. As a result, it is possible to suppress deterioration of image quality caused by an incorrect motion vector.

In addition, although video having a motion indicated by the calculated motion vector is displayed, by calculating the reliability value of the calculated motion vector, determining a control pattern based on the calculated reliability value, and performing light-emission control according to the determined control pattern, it is possible to suppress light emission of subfields having larger luminance weights at inappropriate positions based on an incorrect motion vector, and to achieve sufficient improvement in performance while suppressing image blur and flicker.

Here, with this image display apparatus, the motion vector calculation unit is configured to specify a second picture which is different from the first picture (pixel, block displayed by the field) in time but has pixels that match pixels of the first picture, and to calculate a vector between the first picture and the second picture as the motion vector of the first picture, and the reliability value calculation unit is configured to calculate a reliability value based on: a sum of differences between the pixels of the first picture and the pixels of the second picture (the reliability coefficient 1); and respective motion vectors of pictures surrounding the first picture for which the motion vector has been calculated (vectors of eight blocks surrounding a current block, see FIG. 2, for example), the reliability value becoming greater as an absolute value of the sum of the differences between the pixels (the reliability coefficient 1) decreases and as a difference between the calculated motion vector and each of the respective motion vectors of the surrounding pictures decreases.

This structure allows the motion vector calculation and the reliability value calculation to be performed with a simple structure, which in turn makes it possible to provide the image display apparatus with a simple structure.

With this image display apparatus, the subfield display control unit is configured to cause the respective subfields to emit light at predetermined pixel positions (the pixel positions of the respective subfields shown in FIGS. 3A and 3B) with respective timings (the start timings of the respective subfields shown in FIGS. 3A and 3B, for example) specified for the subfields according to the determined control pattern, the pixel positions at which the light emission occurs are pixel positions (the second lowest pixel position for SF2 in FIG. 3A, for example) shifted from a pixel position (the lowest pixel position among the six pixel positions in FIG. 3A, the lowest pixel position among the four pixel positions in FIG. 3B) of a motion-vector-starting-point subfield (SF4 in FIG. 3A, SF4 in FIG. 3B) at which the calculated motion vector (shown as solid arrows in FIGS. 3A and 3B) makes a starting point, according to the calculated motion vector, the shift to the light-emission pixel positions is a shift (shift according to a multiplication result obtained by multiplying the motion vector by time) in time from a light-emission timing of the motion-vector-starting-point subfield (the start timing of SF4 in FIG. 3A, for example) to the respective timings of the subfields (SF2, for example), and the subfield display control unit is configured to determine, as the control pattern, a first control pattern (the control pattern of FIG. 3B) when the calculated reliability value is greater than a predetermined threshold (the threshold level) (YES in S3 in FIG. 6), and a second control pattern (the control pattern of FIG. 3A) different from the first control pattern when the calculated reliability value is equal to or smaller than the predetermined threshold (No in S3 in FIG. 6).

Thus, the timings and pixel positions of the subfields to be used are changed depending on whether the reliability value is higher than a threshold value or the reliability value is equal to or less than a threshold value, which makes it possible to suppress image-quality deterioration caused by an incorrect motion vector to a greater extent than in the case of changing only the elements other than the timings and so on.

With this image display apparatus, the first control pattern determined when the calculated reliability value is greater (the control pattern of FIG. 3B) is a control pattern in which respective timings of subfields having a light-emission time period equal to or longer than a predetermined period (SF4 and SF3, for example) are dispersed, and the second control pattern determined when the calculated reliability value is not greater (the control pattern of FIG. 3A) is a control pattern in which the respective timings of the subfields having the light-emission time period equal to or longer than the predetermined period (SF4 and SF3 in FIG. 3A, for example) are concentrated.

To be more specific, with this image display apparatus, the second control pattern determined when the calculated reliability value is not greater (the control pattern of FIG. 3A) is a control pattern that defines, only for a subfield (SF3 and SF4 in FIG. 3A) having a timing that is closer to the timing of the motion-vector-starting-point subfield (SF4 in FIG. 3A) than a timing determined by the first control pattern (the control pattern of FIG. 3B) for a predetermined subfield (SF3, for example), a light-emission time period equal to or longer than a light-emission time period determined by the first control pattern (the control pattern of FIG. 3B) for the predetermined subfield (SF3).

Therefore, the second control pattern determined in the case of a low reliability value (the control pattern of FIG. 3A) is a control pattern in which the subfields having a long light-emission time period (SF4 and SF3 in FIG. 3A) are only the subfields close to the timing of a motion-vector-starting-point subfield, and thus the timings of the subfields having a long light-emission time period are concentrated, whereas the first control pattern determined in the case of a high reliability value (the control pattern of FIG. 3B) is a control pattern in which some of the subfields having a long light-emission time period (SF3 in FIG. 3B) are away from the timing of the motion-vector-starting-point subfield, and thus the timings of the subfields having a long light-emission time period are dispersed.

Thus, in the case of a low reliability value, the subfields having a long light-emission time period emit light only near the motion-vector-starting-point pixel position, thereby making it possible to adequately suppress the image-quality deterioration caused by an incorrectly calculated motion vector.

Further, in the case of a high reliability value, some of the subfields having a long light-emission time period emit light even at pixel positions away from the motion-vector-starting-point pixel position, and thus the light-emission timings of the subfields having a long light-emission time period are dispersed, thereby making it possible to prevent flicker caused by light emission, within a short period of time, of the subfields having a long light-emission time, and thus flicker can be reliably suppressed.

It is to be noted that with the image display apparatus, the first control pattern determined in the case of a high reliability value (the control pattern of FIG. 4C, for example) is a control pattern that defines a subfield (SF2 in FIG. 4C) other than the motion-vector-starting-point subfield and having a light-emission time period equal to or longer than that of the motion-vector-starting-point subfield (SF4 in FIG. 4C).

This makes it possible to sufficiently disperse the timings of the subfields having a long light-emission time period.

Alternatively, with this image display apparatus, the first control pattern determined when the calculated reliability value is greater (the control pattern of FIG. 4C, for example) is a control pattern in which respective timings of subfields having a light-emission time period longer than a predetermined period are equally dispersed.

Further, with this image display apparatus, the first control pattern is a control pattern in which the number of local-maximum-point subfields (SF5, SF4, and SF3 in FIG. 4C) is larger (three in FIG. 4C) than the number (one in FIG. 4A and two in FIG. 4B) of local-maximum-point subfields of the second control pattern (SF4 only, in the control pattern of FIG. 4A, and SF4 and SF3 in the control pattern of FIG. 4B), each of the local-maximum-point subfields having a light-emission time period longer than each of light-emission time periods of adjacent subfields.

Thus, the first control pattern determined in the case of a high reliability value (the control pattern of FIG. 4C) is a control pattern having a larger number of local maximum points and thus there are many subfields having a long light-emission time period. Therefore, the timings of the subfields having a long light-emission time period are equally dispersed, thereby allowing adequate suppression of flicker.

Furthermore, with this image display apparatus, the first control pattern (the control pattern of FIG. 4C) is a control pattern in which a total length of the respective light-emission time periods defined for the subfields is equal to a total length of the light-emission time periods defined by the second control pattern (the control patterns of FIGS. 4A and 4B), and in which a longest light-emission time period (the light-emission time period of SF5 in FIG. 4C, for example) of the light-emission time periods is shorter than a longest light-emission time period (the light-emission time period of SF4 in FIG. 4A, and the light-emission time period of SF4 in FIG. 4B) of the light-emission time periods defined by the second control pattern.

Thus, in the first control pattern determined in the case of a high reliability value (the control pattern of FIG. 4C), the period of the longest light-emission time is shorter, which allows subfields (SF4 in FIG. 4C) other than the subfield having the longest light-emission time period (SF5 in FIG. 4C, for example) to have a long light-emission time period. As a result, light emission of plural subfields having a long light-emission time period (SF5, SF4, and SF3 in FIG. 4C) allows dispersion of the light-emission timings of the subfields having a long light-emission time period, thereby making it possible to more adequately suppress flicker.

Alternatively, with this image display apparatus, the subfield display control unit is configured to cause the subfields to emit light at respective pixel positions based on a motion vector (the gain-applied motion vector) having a magnitude reduced to a predetermined proportion of a magnitude of the motion vector calculated by the motion vector calculation unit when the reliability value calculated by the reliability value calculation unit is smaller than a predetermined threshold.

Thus, when there is a possibility that an incorrect motion vector with a low reliability value is calculated, each subfield emits light at a pixel position closer to the motion-vector-starting-point pixel position, thereby allowing more adequate suppression of image-quality deterioration caused by an incorrect motion vector.

In addition, each subfield emits light not at the motion-vector-starting-point pixel position but at a pixel position away from the motion-vector-starting-point pixel position by a distance according to the predetermined proportion, thereby achieving suppression of image-quality deterioration caused by motions in pictures. This means that it is possible to achieve both the suppression of image-quality deterioration caused by motions in pictures and the suppression of image-quality deterioration caused by an incorrect motion vector.

Alternatively, with this image display apparatus, the subfield display control unit is configured to: cause the subfields to emit light at respective pixel positions (the pixel position of SF1, for example) each of which is shifted from the pixel position of the motion-vector-starting-point subfield (the pixel position of SF4 in FIG. 3B, for example) at which the calculated motion vector (the motion vector shown as the solid arrow in FIG. 3B, for example) makes a starting point, only when the calculated reliability value is greater than the threshold; and cause all the subfields to emit light at the pixel position of the motion-vector-starting-point subfield (the pixel position of SF4 in FIG. 3B) when the reliability value is equal to or smaller than the threshold.

Thus, in the case of a low reliability value, each subfield emits light at the motion-vector-starting-point pixel position, thereby making it possible to reliably and adequately suppress image-quality deterioration caused by an incorrect motion vector.

### Another Embodiment

Another embodiment described below may be adopted. It is to be noted that as a variation of the other embodiment below, the above described embodiment may be entirely incorporated into the embodiment below.

(1) A light-emission control apparatus according to the other embodiment is a light-emission control apparatus (the video display apparatus 1) which performs multi-level gradation display of a picture of one field for a plasma display by controlling light emission of subfields into which the field is divided, the light-emission control apparatus (the video display apparatus 1) comprising:

a reliability value calculation unit (the reliability calculation unit 103) configured to calculate a reliability value of a motion vector of the picture; and

a subfield display control unit (the subfield display control unit 104) configured to: cause the subfields to emit light from respective timings of the subfields in a duration of the field for respective light-emission time periods of the subfields; cause the subfields to emit light at respective pixel positions shifted according to the motion vector, for which the reliability value has been calculated, for a time difference between a light-emission timing of a motion-vector-starting-point subfield at which the motion vector makes a starting point and the respective timings of light emission of the subfields; and when the reliability value of the motion vector is equal to or smaller than a predetermined threshold, (i) cause only a subfield having a timing closer to the timing of the motion-vector-starting-point subfield than a predetermined timing to emit light for a light-emission time period longer than a light-emission time period of a subfield having the predetermined timing that is different from the timing of the motion-vector-starting-point subfield when the reliability value is greater than the threshold, and (ii) cause a subfield having a timing farther away from the timing of the motion-vector-starting-point subfield than the predetermined timing to emit light only for a light-emission time period equal to or less than the light-emission time period of the subfield having the predetermined timing.

(2) The light-emission control apparatus according to the other embodiment may further comprise

a motion vector calculation unit (the image processing unit 100) configured to calculate the motion vector used by the subfield display control unit,

wherein the subfield display control unit may cause the subfields to emit light at respective pixel positions shifted from a pixel position of the motion-vector-starting-point subfield according to the motion vector within a time difference between the timing of the motion-vector-starting-point subfield and the respective timings of the subfields.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be applied to a technique for improving video resolution by an image display apparatus that performs multi-level gradation display by causing subfields, into which video is divided, to emit light.

What is claimed is:

1. An image display apparatus which performs multi-level gradation display of a picture of one field by controlling light emission of subfields into which the field is divided, said image display apparatus comprising:
a motion vector calculation unit configured to calculate a motion vector of the picture which is a first picture;
a reliability value calculation unit configured to calculate a reliability value of the calculated motion vector; and
a subfield display control unit configured to determine a subfield control pattern based on the calculated reliability value, and to control the light emission according to the determined subfield control pattern.

2. The image display apparatus according to claim 1,
wherein said motion vector calculation unit is configured to specify a second picture which is different from the first picture in time but has pixels that match pixels of the first picture, and to calculate a vector between the first picture and the second picture as the motion vector of the first picture, and
said reliability value calculation unit is configured to calculate a reliability value based on: a sum of differences between the pixels of the first picture and the pixels of the second picture; and respective motion vectors of pictures surrounding the first picture for which the motion vector has been calculated, the reliability value becoming greater as an absolute value of the sum of the differences between the pixels decreases and as a difference between the calculated motion vector and each of the respective motion vectors of the surrounding pictures decreases.

3. The image display apparatus according to claim 2,
wherein said subfield display control unit is configured to cause the respective subfields to emit light at predetermined pixel positions with respective timings specified for the subfields according to the determined control pattern,
the pixel positions at which the light emission occurs are pixel positions shifted from a pixel position of a motion-vector-starting-point subfield at which the calculated motion vector makes a starting point, according to the calculated motion vector,
the shift to the light-emission pixel positions is a shift in time from a light-emission timing of the motion-vector-starting-point subfield to the respective timings of the subfields, and
said subfield display control unit is configured to determine, as the control pattern, a first control pattern when the calculated reliability value is greater than a predetermined threshold, and a second control pattern different from the first control pattern when the calculated reliability value is equal to or smaller than the predetermined threshold.

4. The image display apparatus according to claim 3,
wherein the first control pattern determined when the calculated reliability value is greater is a control pattern in which respective timings of subfields having a light-emission time period equal to or longer than a predetermined period are dispersed, and
the second control pattern determined when the calculated reliability value is not greater is a control pattern in which the respective timings of the subfields having the light-emission time period equal to or longer than the predetermined period are concentrated.

5. The image display apparatus according to claim 4,
wherein the second control pattern determined when the calculated reliability value is not greater is a control pattern that defines, only for a subfield having a timing that is closer to the timing of the motion-vector-starting-point subfield than a timing determined by the first control pattern for a predetermined subfield, a light-emission time period equal to or longer than a light-emission time period determined by the first control pattern for the predetermined subfield.

6. The image display apparatus according to claim 3,
wherein the first control pattern determined when the calculated reliability value is greater is a control pattern in which respective timings of subfields having a light-emission time period longer than a predetermined period are equally dispersed.

7. The image display apparatus according to claim 6,
wherein the first control pattern is a control pattern in which the number of local-maximum-point subfields is larger than the number of local-maximum-point subfields of the second control pattern, each of the local-maximum-point subfields having a light-emission time period longer than each of light-emission time periods of adjacent subfields.

8. The image display apparatus according to claim 4,
wherein the first control pattern is a control pattern in which a total length of the respective light-emission time periods defined for the subfields is equal to a total length of the light-emission time periods defined by the second control pattern, and in which a longest light-emission time period of the light-emission time periods is shorter than a longest light-emission time period of the light-emission time periods defined by the second control pattern.

9. The image display apparatus according to claim 3,
wherein said subfield display control unit is configured to cause the subfields to emit light at respective pixel positions based on a motion vector having a magnitude reduced to a predetermined proportion of a magnitude of the motion vector calculated by said motion vector calculation unit when the reliability value calculated by said reliability value calculation unit is smaller than a predetermined threshold.

10. The image display apparatus according to claim 3,
wherein said subfield display control unit is configured to:
cause the subfields to emit light at respective pixel positions each of which is shifted from the pixel position of the motion-vector-starting-point subfield, only when the calculated reliability value is greater than the threshold; and
cause all the subfields to emit light at the pixel position of the motion-vector-starting-point subfield when the reliability value is equal to or smaller than the threshold.

11. An integrated circuit which causes multi-level gradation display by controlling light emission of subfields into which one field displaying a picture is divided, said integrated circuit comprising:
a motion vector calculation unit configured to calculate a motion vector of the picture;
a reliability value calculation unit configured to calculate a reliability value of the calculated motion vector; and
a subfield display control unit configured to determine a subfield control pattern based on the calculated reliability value, and to control the light emission according to the determined subfield control pattern.

12. A computer program product, recorded on a computer-readable recording medium, for performing multi-level gradation display by controlling light emission of subfields into which one field displaying a picture is divided, said computer program causing a computer to execute:
calculating a motion vector of the picture;
calculating a reliability value of the calculated motion vector; and
causing a predetermined light-emission control apparatus to determine a subfield control pattern based on the calculated motion vector and the calculated reliability value and to control the light emission according to the determined subfield control pattern.
